(19) United States
(12) Patent Application Publication
(10) Pub. No.: US 2021/0049957 A1
(43) Pub. Date: Feb. 18, 2021

(54) PIXEL AND DISPLAY DEVICE INCLUDING THE SAME

(71) Applicant: SAPIEN SEMICONDUCTORS INC., Ulsan (KR)

(72) Inventor: Jae Hoon LEE, Ulsan (KR)

(73) Assignee: SAPIEN SEMICONDUCTORS INC., Ulsan (KR)

(21) Appl. No.: 17/051,345

(22) PCT Filed: Dec. 14, 2018
(86) PCT No.: PCT/KR2018/015906

§ 371 Date: Oct. 28, 2020

(30) Foreign Application Priority Data
Jun. 28, 2018 (KR) 10-2018-0074941
Nov. 13, 2018 (KR) 10-2018-0139405

(51) Int. Cl. G09G 3/32

(52) U.S. Cl. CPC G09G 3/32; G09G 2300/0842; G09G 2300/046; G09G 2310/06

(57) ABSTRACT

The present embodiments disclose a pixel and a display device including the same.

A pixel according to an embodiment of the present disclosure comprises a luminous element and a pixel circuit connected to the luminous element, wherein the pixel circuit includes a first pixel circuit including a memory storing bit values of multi-bit data corresponding to image data of a single frame and a pulse width modulation (PWM) controller configured to generate a PWM signal based on the bit values and a clock signal that is output in accordance with each bit of the multi-bit data and a second pixel circuit configured to adjust a light-emission time and a non-light-emission time of the luminous element during a single frame in response to the PWM signal.

### TECHNICAL FIELD

The present embodiments relate to a pixel and a display device including the same.

### BACKGROUND ART

With the progress of information society, the demand for image display devices is increasing, and in line with this, various types of display devices such as liquid crystal display devices, plasma display devices, and organic light-emitting display devices or the like are in use. Recently, interest in display devices using micro-light-emitting diodes (pLED) (hereinafter, “micro display devices”) is increasing.

As excellent display device characteristics for VR (Virtual Reality), AR (Augmented Reality), MR (Mixed Reality) technology is demanded, development of micro LED on Silicon or AMOLED on Silicon is growing, and particularly, the demand for minimizing the pixel size is increasing for implementation of high resolution.

### DESCRIPTION OF EMBODIMENTS

### Technical Problem

An embodiment of the present disclosure is to provide a display device capable of reducing power consumption and implementing good matching characteristics.

### Solution to Problem

A pixel according to an embodiment of the present disclosure includes a luminous element and a pixel circuit connected to the luminous element, wherein the pixel circuit includes a first pixel circuit including a memory storing bit values of multi-bit data corresponding to image data of a single frame and a pulse width modulation (PWM) controller configured to generate a PWM signal based on the bit values and a clock signal that is output in accordance with each bit of the multi-bit data and a second pixel circuit configured to adjust a light-emission time and a non-light-emission time of the luminous element during a single frame in response to the PWM signal.

The second pixel circuit may include a first transistor outputting a driving current and a second transistor transmitting or blocking the driving current to the luminous element according to the PWM signal.

The second pixel circuit may further include a level shifter that converts a voltage level of the PWM signal between the second transistor and the second pixel circuit.

The first transistor may form a current mirror circuit with an external circuit of the pixel.

The memory may receive bit values of the multi-bit data from a driving unit outside the pixel during a data-writing period of the frame, and the PWM controller may generate the PWM signal during a light-emitting period subsequent to the data-writing period, and the second pixel circuit may adjusts a light emission time and a non-emission time of the luminous element during the light-emitting period.

The frame may include a plurality of subframes, and each of the plurality of subframes may include a data-writing period and a light-emitting period, and during a data-writing period of each subframe, the memory may receive, from the driving unit outside the pixel, and store a corresponding bit string from among a plurality of bit strings of n-bit data, wherein the plurality of bit strings are generated by a combination of bits in the number of n, which is smaller than m, from among m bits constituting a bit string of the multi-bit data, and during a light-emitting period of each subframe, the PWM controller may generate the PWM signal based on n bit values of the corresponding bit string stored in the memory and n clock signals, and the number of the bit strings of the n-bit data may be equal to the number of the subframes, and a light-emitting period of each subframe may be a sum of times respectively allocated to bits of the corresponding bit string, and the n-bit data may be a bit string in which n bits from among the m bits are combined such that a difference in light-emitting periods of the plurality of subframes is minimized.

n may be (m/2)+1 or (m/2)−1, and two bit strings from among the bit strings of the n-bit data may include, as a common bit, at least one particular bit of the bit string of the m-bit data, and a time allocated to the common bit may be half a time allocated to the at least one particular bit in the bit string of the m-bit data.

n may be m/2, and the bit strings of the n-bit data may not include bits at the same positions among the m bits, and sums of time allocated to each bit of the respective bit strings of the n-bit data are approximate to one another.

A display device according to an embodiment of the present disclosure includes: a pixel unit in which a plurality of pixels are arranged, each pixel including a luminous element and a pixel circuit connected to the luminous element; and a driving unit arranged around the pixel unit, wherein the driving unit includes a data driving unit providing bit values of multi-bit data corresponding to image data of a single frame, to the plurality of pixels; and a clock generator supplying a clock signal to the plurality of pixels, wherein each pixel circuit of the plurality of pixels includes: a first pixel circuit including a memory storing bit values of multi-bit data applied from the data driving unit and a pulse width modulation (PWM) controller configured to generate a PWM signal based on the bit values and on a clock signal that is output in accordance with each bit of the multi-bit data applied from the clock generator; and a second pixel circuit configured to adjust a light-emission time and a non-light-emission time of the luminous element during a single frame in response to the PWM signal.

The memory may receive bit values of the multi-bit data from a data driving unit during a data-writing period of the frame, and the PWM controller may generate the PWM signal during a light-emitting period subsequent to the data-writing period, and the second pixel circuit may adjust light emission and non-emission times of the luminous element during the light-emitting period.

The frame may include a plurality of subframes, and each of the plurality of subframes may include a data-writing period and a light-emitting period, and during a data-writing period of each subframe, the memory may receive, from the data driving unit, and store a corresponding bit string from among a plurality of bit strings of n-bit data, wherein the plurality of bit strings are generated by a combination of bits in the number of n, which is smaller than m, from among m bits constituting a bit string of the multi-bit data, and the PWM controller may generate the PWM signal based on n bit values of a corresponding bit string, stored in the memory, and n clock signals, during a light-emitting period of each subframe, and the number of the bit strings of the n-bit data may be equal to the number of the subframes, and a light-emitting period of each subframe may be a sum of times respectively allocated to bits of the corresponding bit string, and the n-bit data may be a bit string in which n bits from among the m bits are combined such that a difference in light-emitting periods of the plurality of subframes is minimized.

n may be (m/2)+1 or (m/2)−1, and two bit strings from among the bit strings of the n-bit data may include, as a common bit, at least one particular bit of the bit string of the m-bit data, and a time allocated to the common bit may be half a time allocated to the at least one particular bit in the bit string of the m-bit data.

n is m/2, and the bit strings of the n-bit data may not include bits at the same positions among the m bits, and sums of time allocated to each bit of the respective bit strings of the n-bit data may be approximate to one another.

### Advantageous Effects of Disclosure

A display device according to an embodiment of the present disclosure may implement a pixel circuit whereby power consumption is reduced and which has good matching characteristics. In addition, the display device according to the embodiment of the present disclosure may minimize time difference among subframes and also implement a small-sized pixel circuit.

### BRIEF DESCRIPTION OF DRAWINGS

FIG. 1 is a diagram schematically illustrating a manufacturing process of a display device according to an embodiment of the present disclosure.

FIGS. 2 and 3 are diagrams schematically illustrating a display device according to an embodiment of the present disclosure.

FIG. 4 is a diagram illustrating an example of time allocated to bits, according to an embodiment of the present disclosure.

FIG. 5 is a circuit diagram illustrating a current supply unit according to an embodiment of the present disclosure.

FIG. 6 is a circuit diagram illustrating a pixel PX according to an embodiment of the present disclosure.

FIG. 7 is a diagram illustrating a connection relationship between a current supply unit and a pixel according to an embodiment of the present disclosure.

FIG. 8 is a diagram for describing driving of a pixel according to an embodiment of the present disclosure.

FIG. 9 is a diagram for explaining driving of a pixel according to another embodiment of the present disclosure.

FIG. 10 is a diagram schematically illustrating a display device according to another embodiment of the present disclosure.

FIG. 11 is a circuit diagram illustrating a pixel PX of the display device of FIG. 10.

FIG. 12 is a diagram for describing data division by the display device of FIG. 10.

FIG. 13 is a diagram for describing bit data division according to an embodiment of the present disclosure.

FIG. 14 is a diagram for describing driving timing of a clock signal according to an embodiment of the present disclosure.

FIG. 15 is a diagram for describing bit data division according to another embodiment of the present disclosure.

FIG. 16 is a diagram for describing driving timing of a clock signal according to another embodiment of the present disclosure.

FIG. 17 is a diagram for describing bit data division according to another embodiment of the present disclosure.

FIG. 18 is a diagram for describing driving timing of a clock signal according to another embodiment of the present disclosure.

### BEST MODE OF DISCLOSURE

A pixel according to an embodiment of the present disclosure includes a luminous element and a pixel circuit connected to the luminous element, wherein the pixel circuit includes a first pixel circuit including a memory storing bit values of multi-bit data corresponding to image data of a single frame and a pulse width modulation (PWM) controller configured to generate a PWM signal based on the bit values and a clock signal that is output in accordance with each bit of the multi-bit data and a second pixel circuit configured to adjust a light-emission time and a non-light-emission time of the luminous element during a single frame in response to the PWM signal.

### Mode of Disclosure

Since the present disclosure may apply various transformations and have various embodiments, specific embodiments will be illustrated in a diagram and described in detail in the detailed description. The effects and features of the present disclosure, and a method of achieving them, will be clarified with reference to the embodiments described later in detail together with diagrams. However, the present disclosure is not limited to the embodiments disclosed below and may be implemented in various forms.

Hereinafter, embodiments of the present disclosure will be described in detail with reference to attached diagrams, and when describing with reference to diagrams, the same or corresponding constituent elements are assigned the same diagram symbol, and redundant descriptions thereof will be omitted.

In the following embodiments, terms such as first and second are used for distinguishing one constituent element from other constituent elements. These constituent elements should not be limited by these terms. In addition, in the following embodiments, expressions in the singular include plural expressions unless the context clearly indicates otherwise.

In the following embodiments, the connection between X and Y may include a case where X and Y are electrically connected, a case where X and Y are functionally connected, and a case where X and Y are directly connected. Here, X and Y may be objects (for example, devices, elements, circuits, wirings, electrodes, terminals, conductive films, layers, etc.). Therefore, it is not limited to a certain connection relationship, for example, a connection relationship indicated in a diagram or the detailed description, and may include other connection relationships than that indicated in a diagram or the detailed description.

The case where X and Y are electrically connected may include, for example, a case where at least one element that enables the electrical connection of X and Y (e.g., a switch, a transistor, a capacitor, an inductor, a resistance element, a diode, etc.) is connected between X and Y.

The case where X and Y are functionally connected may include a case where at least one circuit of a circuit that enables a functional connection of X and Y, like in a case where the signal output from X is transmitted to Y (e.g., a logic circuit (OR gate, inverter, etc.), a signal conversion circuit (an AD conversion circuit, a gamma correction circuit, etc.), a potential level conversion circuit (a level shifter circuit, etc.), a current supply circuit, an amplification circuit (a circuit that may increase signal amplitude or current amount, etc.), a signal generation circuit, and a memory circuit (a memory, etc.), is connected between X and Y.

In the following embodiments, “ON” used in connection with the element state may refer to an activated state of the element, and “OFF” may refer to an inactive state of the device. “On” used in connection with a signal received by the element may refer to a signal that activates the element, and “off” may refer to a signal that disables the element. The element may be activated by a high voltage or a low voltage. For example, the P-type transistor is activated by a low voltage, and the N-type transistor is activated by a high voltage. Therefore, it should be understood that the “on” voltage for the P-type transistor and the N-type transistor is the opposite (low vs. high) voltage level.

In the following embodiments, terms such as include or have means that the features or elements described in the specification are present, and do not preclude the possibility that one or more other features or elements may be added.

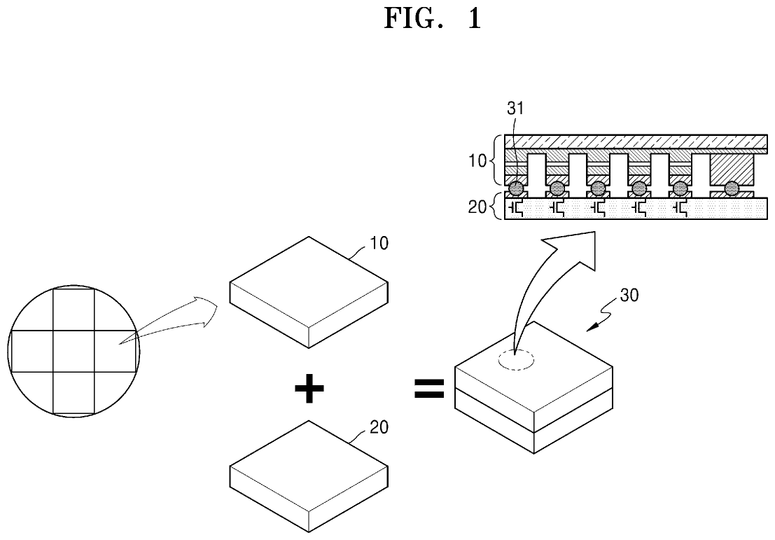

FIG. 1 is a diagram schematically illustrating a manufacturing process of a display device 30 according to an embodiment of the present disclosure.

Referring to FIG. 1, the display device 30 according to an embodiment may include a luminous element array 10 and a driving circuit board 20. The luminous element array 10 may be coupled with the driving circuit board 20.

The luminous element array 10 may include a plurality of luminous elements. A luminous element may be a light-emitting diode (LED). A luminous element may be a micro-LED. The luminous element may be a LED having a micro to nano unit size. At least one luminous element array 10 may be manufactured by growing a plurality of LEDs on a semiconductor wafer (SW). Accordingly, the display device 30 may be manufactured by coupling the luminous element array 10 with the driving circuit board 20, without the need to individually transfer the LED to the driving circuit board 20.

The driving circuit board 20 may be a Si-complementary metal oxide semiconductor (CMOS) substrate in which pixel circuits are arranged, the pixel circuits corresponding to and independently controlling the respective LED on the luminous element array 10. A pixel circuit may include at least one transistor and at least one capacitor.

A micro-LED requires a high processing temperature equal to or higher than 1000° C., and cannot be directly grown or patterned on the transistor of the driving circuit board 20. In the embodiment of the present disclosure, the luminous element array 10 and a pixel circuit array on the driving circuit board 20 may be separately formed and then coupled with each other by using a coupling member 31 such that the LED of the luminous element array 10 is electrically connected to the pixel circuit of the driving circuit board 20 to thereby constitute a pixel PX. At this time, accurate arrangement between the pixel circuit array and the light emitting diode array is important. The coupling member 31 may include a solder material including a conductive material, a conductive micro-tube or the like, and is not limited thereto in the embodiments of the present disclosure.

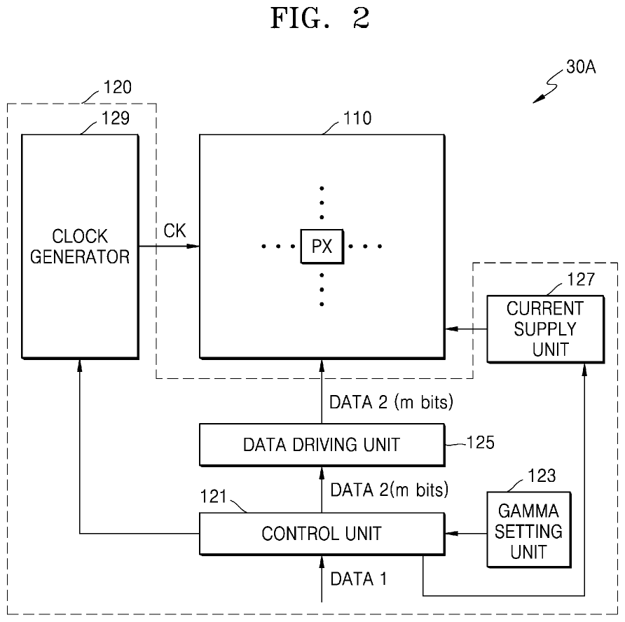

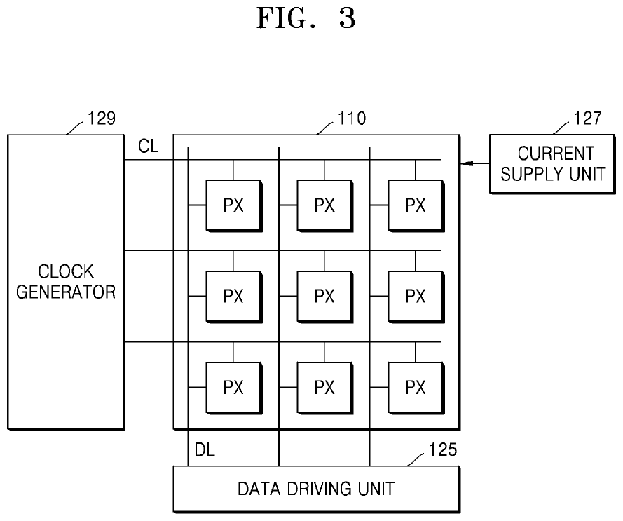

FIGS. 2 and 3 are diagrams schematically illustrating a display device according to an embodiment of the present disclosure.

Referring to FIGS. 2 and 3, a display device 30A may include a pixel unit 110 and a driving unit 120.

The pixel unit 110 may display an image by using an m-bit digital image signal capable of displaying 1 to 2^{m} gray scales. The pixel unit 110 may include a plurality of pixels PX arranged in a certain pattern, for example, a matrix-type pattern or a zigzag-type pattern. The pixel PX emits light of a single color, and may emit, for example, light of red, blue, green, or white. The pixel PX may emit light of other colors than red, blue, green, and white. The pixel PX may include one or more sub-pixels. For example, a pixel PX may include a red subpixel emitting red light, a green subpixel emitting green light, and a blue subpixel emitting blue light.

The pixel PX may include a luminous element. The luminous element may be a self-luminous element. For example, the luminous element may be an inorganic LED (LED). A luminous element may be a micro-LED. The luminous element may emit light having a single peak wavelength or may emit light having a plurality of peak wavelengths.

The pixel PX may further include a pixel circuit connected to the luminous element. The pixel circuit may include at least one transistor and at least one capacitor. The transistor may be a CMOS transistor. The pixel PX may operate in a frame unit. Each frame may include a data-writing period and a light-emitting period. During a data-writing period, digital data of certain bits may be applied to a pixel PX and stored therein. During a light-emitting period, digital data of certain bits may be synchronized with a clock signal to be read, and the digital data may be converted into a PWM signal, so that the pixel PX may express gradation. The driving unit 120 may drive and control the pixel unit 110. The driving unit 120 may include a control unit 121, a gamma setting unit 123, a data driving unit 125, a current supply unit 127, and a clock generator 129. The driving unit 120 may be located in a non-display unit around the pixel unit 110.

The control unit 121 may receive input image data DATA1 of one frame from the outside (for example, a graphic controller), and receive a correction value from the gamma setting unit 123 to perform gamma correction on the input image data DATA1 by using the correction value, thereby generating correction image data DATA2.

The control unit 121 may extract gradation of each pixel PX from the correction image data DATA2 of one frame and convert the extracted gradation into multi-bit digital data of a certain preset number of bits (for example, m bits). The multi-bit digital data may be a pixel value corresponding to luminance of each pixel. Here, m may be 1 or more. For example, multi-bit digital data may be 2-bit digital data, 4-bit digital data, 6-bit digital data, 8-bit digital data, or 10-bit digital data.

The control unit 121 may output digital data to the data driving unit 125. The control unit 121 may output, to the data driving unit 125, from a most significant bit MSB to a least significant bit LSB of the digital data in a certain order.

The gamma setting unit 123 may set a gamma value using a gamma curve, set a correction value of image data according to a set gamma value, and output a set correction value to the control unit 121. The gamma setting unit 123 may be provided as a circuit separate from the control unit 121, or may be provided to be included in the control unit 121.

The data driving unit 125 may transfer, to each pixel PX of the pixel unit 110, the digital data from the control unit 121. The data driving unit 125 may provide a bit value included in the digital data to each pixel PX.

The data driving unit 125 may include a line buffer and a shift register circuit. The line buffer may be one line buffer or two line buffers. The data driving unit 125 may serially provide m-bit data to pixels in a line unit (in a row unit). m-bit data may be provided to pixels in parallel compared to a serial bit stream.

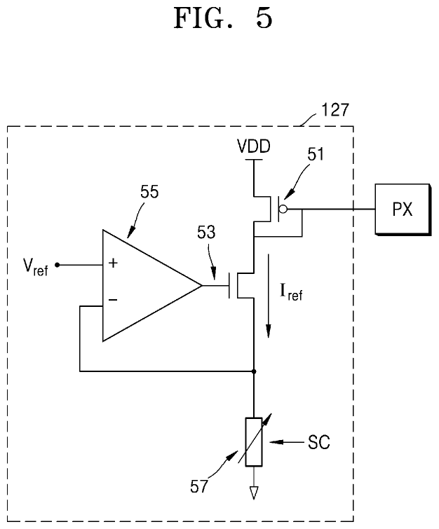

The current supply unit 127 may generate and supply a driving current of each pixel PX. The configuration of the current supply unit 127 will be described later with reference to FIG. 5.

The clock generator 129 may generate a clock signal corresponding to each bit of digital data and output the clock signal to pixels PX. The clock generator 129 may sequentially supply a clock signal to a clock line CL.

Each component of the driving unit 120 may be formed as a separate integrated circuit chip or a single integrated circuit chip, and be mounted directly on a substrate on which the pixel unit 110 is formed, or be mounted on a flexible printed circuit film, or be attached in a form of a TCP (tape carrier package) on a substrate, or be formed directly on the substrate. In one embodiment, the control unit 121, the gamma setting unit 123, and the data driving unit 125 may be connected to the pixel unit 110 in the form of an integrated circuit chip, and the current supply unit 127 and the clock generator 129 may be formed directly on the substrate.

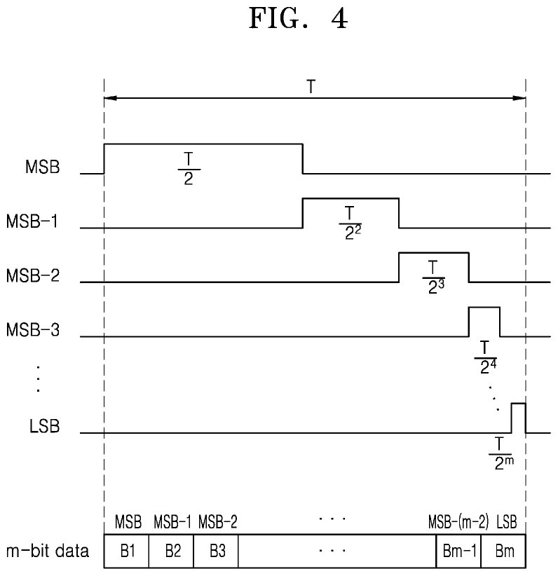

FIG. 4 is a diagram illustrating an example of time allocated to bits, according to an embodiment of the present disclosure.

m-bit data may be a bit string including m bit values from a most significant bit MSB (B1) to a least significant bit LSB (Bm). The bit value may have one of a first logic level and a second logic level. The first logic level may be a high level and the second logic level may be a low level. Alternatively, the first logic level may be a low level and the second logic level may be a high level. In FIG. 4, an example of a bit string (1011100110) of 10-bit data of a pixel PX is illustrated, and the leftmost bit (B0), 1, is the MSB, and the rightmost bit Bm, 0, is the LSB.A time set to each bit of the m-bit data may vary according to positions of the bits. For example, a first time (T/2), which is the longest, may be allocated to the most significant bit MSB, and a second time (T/2²) may be allocated to the next higher bit MSB-1, and in this manner, an m-th time (T/2^{m}), which is the shortest, may be allocated to the least significant bit LSB. A sum of times respectively allocated to bits of the m-bit data may be equal to or approximate to a time T allocated to one frame. The clock generator 129 may generate and output a clock signal for an operation time corresponding to a position of each bit of the m-bit data. The clock generator 129 may generate corresponding clock signals based on an output order of bits in which m-bit data is output from the data driving unit 125. For example, when the bit output order of 4-bit data is MSB(B1)/MSB-1(B2)/MSB-2(B3)/LSB(B4), the clock generator 129 may sequentially output a first clock signal to a fourth clock signal in the order of MSB(B1), MSB-1(B2), MSB-2(B3), and LSB(B4). When the bit output order of 4-bit data is MSB(B1)/MSB-2(B3)/MSB-1(B2)/LSB(B4), the clock generator 129 may sequentially output clock signals in the order of a first clock signal, a third clock signal, a second clock signal, and a fourth clock signal according to the order of MSB(B1), MSB-2(B3), MSB-1(B2), MSB-3(B4), and LSB(B4).

FIG. 5 is a circuit diagram illustrating a current supply unit according to an embodiment of the present disclosure.

Referring to FIG. 5, the current supply unit 127 may include a first transistor 51, a second transistor 53, an operational amplifier 55, and a variable resistor 57.

The first transistor 51 has a gate connected to the pixel PX, a first terminal connected to a supplier of a power voltage VDD, and a second terminal connected to the gate and a first terminal of the second transistor 53.

The second transistor 53 has a gate connected to an output terminal of the operational amplifier 55, the first terminal connected to the second terminal of the first transistor 51, and a second terminal connected to a second input terminal (−) of the operational amplifier 55.

A first input terminal (+) of the operational amplifier 55 is connected to a supplier of a reference voltage V_{ref}, and the second input terminal (−) is connected to the variable resistor 57. The output terminal of the operational amplifier 55 is connected to the gate of the second transistor 53. When the reference voltage V_{ref} is applied to the first input terminal (+), the second transistor 53 may be turned on or off according to the voltage at the output terminal due to the voltage difference among the first input terminal (+), the second input terminal (−) and the output terminal.

A resistance value of the variable resistor 57 may be determined according to a control signal SC from the control unit 121. Depending on the resistance value of the variable resistor 57, a voltage of the output terminal of the operational amplifier 55 VDD may be changed, and the current I_{ref} flowing along the first transistor 51 and second transistor 53 turned on from the power voltage VDD may be determined.

The current supply unit 127 may supply a driving current corresponding to the current I_{ref} to the pixel PX by configuring a current mirror together with a transistor in the pixel PX. The driving current may determine a total luminance (brightness) of the pixel unit 110.

In the above-described embodiment, the current supply unit 127 includes the first transistor 51 implemented as a P-type transistor and the second transistor 53 implemented as an N-type transistor, but the embodiment of the present disclosure is not limited thereto. In one or more embodiments, the first transistor 51 and second transistor 53 may be implemented as different types of transistors, and an operational amplifier corresponding thereto may be configured to form the current supply unit 127.

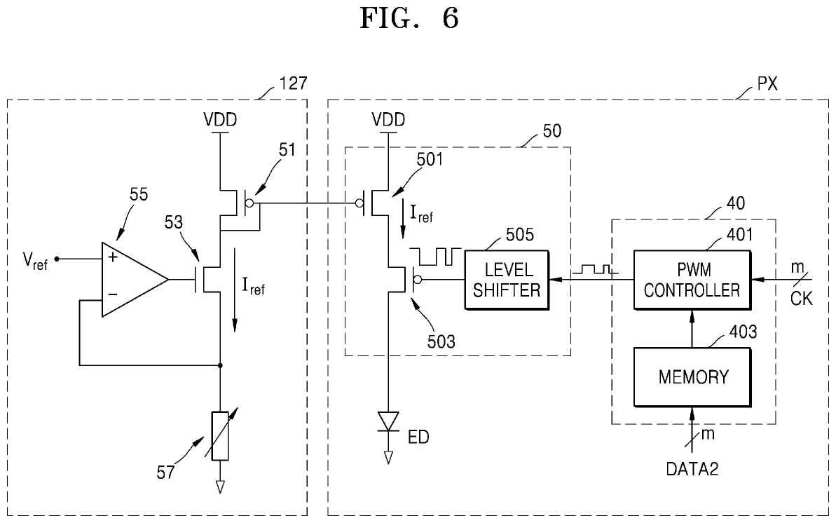

FIG. 6 is a circuit diagram illustrating a pixel PX according to an embodiment of the present disclosure.

Referring to FIG. 6, the pixel PX may include a luminous element ED and a pixel circuit including a first pixel circuit 40 and a second pixel circuit 50 connected thereto. The first pixel circuit 40 may be a low voltage driving circuit, and the second pixel circuit 50 may be a high voltage driving circuit. The first pixel circuit 40 may be implemented as a plurality of logic circuits.

The luminous element ED may selectively emit light based on a bit value (logic level) of image data provided from the data driving unit 125 during a single frame, thereby adjusting the light-emission time within the single frame to display gradation.

For every frame, the first pixel circuit 40 may store a bit value of m-bit data applied from the data driving unit 125 during a data-writing period, and generate a first PWM signal based on the m bit values and m clock signals during the light-emitting period. The first pixel circuit 40 may include a PWM controller 401 and a memory 403.

The PWM controller 401 may generate the first PWM signal based on a clock signal CK input from a clock generator 129 and a bit value of image data read from the memory 403 during the light-emitting period. A signal width of a clock signal may be equal to a time allocated to a bit position of a corresponding bit. The PWM controller 401 may control a pulse width of the first PWM signal based on a bit value of corresponding image data and a signal width of a clock signal. For example, when the bit value of the image data is 1, the pulse output of the PWM signal may be turned on as much as the signal width of the clock signal, and when the bit value of the image data is 0, the pulse output of the PWM signal may be turned off as much as the signal width of the clock signal. That is, an on time and an off time of the pulse output of the PWM signal may be determined by the signal width (signal length) of the clock signal. The PWM controller 401 may include at least one logic circuit (for example, an OR gate circuit, etc.) implemented as at least one transistor.

the memory 403 may be a digital memory capable of receiving and storing in advance, in synchronization with a frame start signal, m-bit image data applied through a data line DL from the data driving unit 125 during the data-writing period. The memory 403 may have a parallel input structure. In the case of a still image, image data previously stored in the memory 403 before an image update or refresh may be used for continuous image display for a plurality of frames.

Bit values (logic levels) of m-bit data may be input from the data driving unit 125 to the memory 403 in a certain order. The memory 403 may store at least 1 bit data. In one embodiment, the memory 403 may be an m-bit memory. m bit values of m-bit data may be written to the memory 403 during a data-writing period of a frame. In another embodiment, the memory 403 may be implemented as a bit memory of less than m depending on a driving frequency. The memory 403 may be implemented as at least one transistor. The memory 403 may be implemented as a random access memory (RAM), for example, SRAM or DRAM.

The second pixel circuit 50 may control light-emission and non-emission of the luminous element ED in response to a control signal applied from the first pixel circuit 40 during a single frame. The control signal may be a pulse width modulation (PWM) signal. The second pixel circuit 50 may include a first transistor 501, a second transistor 503, and a level shifter 505 electrically connected to the current supply unit 127.

The first transistor 501 may output the driving current. The first transistor 501 includes a gate connected to the current supply unit 127, a first terminal connected to the a supplier of power voltage VDD, and a second terminal connected to a first terminal of the second transistor 503. The gate of the first transistor 501 is connected to the gate of the first transistor 51 of the current supply unit 127, thereby forming a current mirror circuit with the current supply unit 127. Accordingly, as the first transistor 51 of the current supply unit 127 is turned on, the first transistor 501 which has been turned on may supply a driving current corresponding to the current I_{ref} formed in the current supply unit 127. The driving current may be equal to the current I_{ref} flowing in the current supply unit 127.

The second transistor 503 may transmit or block the driving current to the luminous element ED according to the PWM signal. The second transistor 503 includes a gate connected to an output terminal of the level shifter 505, the first terminal connected to the second terminal of the first transistor 501, and a second terminal connected to the luminous element ED.

The second transistor 503 may be turned on or off according to the voltage output from the level shifter 505. The light-emission time of the luminous element ED may be adjusted according to the turn-on or turn-off time of the second transistor 503. The second transistor 503 may be turned on when a gate-on-level signal (low level in the embodiment of FIG. 6) is applied to the gate, and transfers the driving current I_{ref} output from the first transistor 501 to the luminous element ED, so that the luminous element ED may emit light. The second transistor 503 may be turned off when a gate-off level signal (high level in the embodiment of FIG. 6) is applied to the gate, and blocks the driving current I_{ref} output from the first transistor 501 from being transferred to the luminous element ED, so that the luminous element ED may not emit light. During a single frame, the light-emission time and the non-emission time of the luminous element ED are controlled by the turn-on time and the turn-off time of the second transistor 503, so that a color depth of the pixel unit 110 may be expressed.

The level shifter 505 may be connected to an output terminal of the PWM controller 401 of the first pixel circuit 40, and may convert a voltage level of a first PWM signal output from the PWM controller 401 to generate a second PWM signal. The level shifter 505 may generate a second PWM signal by converting a first PWM signal into a gate-on voltage level signal capable of turning on the second transistor 503 and a gate-off level signal capable of turning off the second transistor 503. When the first PWM signal output from the PWM controller 401 is sufficient for driving of the second transistor 503, the level shifter 505 may be omitted.

A pulse voltage level of the second PWM signal output by the level shifter 505 may be higher than a pulse voltage level of the first PWM signal, and the level shifter 505 may include a booster circuit that boosts an input voltage. The level shifter 505 may be implemented as a plurality of transistors.

The turn-on time and turn-off time of the second transistor 503 during a single frame may be determined according to a pulse width of the first PWM signal.

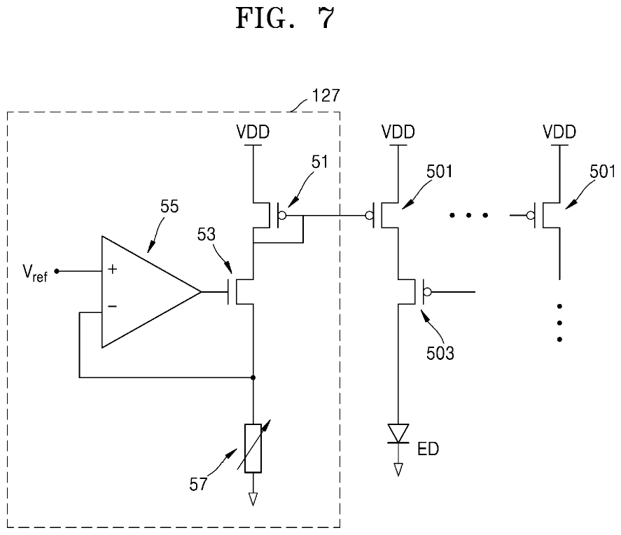

In the embodiment of FIG. 6, the current supply unit 127 is connected to one pixel PX, but the current supply unit 127 may be shared by a plurality of pixels PX. For example, as illustrated in FIG. 7, the first transistor 51 of the current supply unit 127 may be electrically connected to the first transistor 501 of each pixel PX of the pixel unit 110 to form a current mirror circuit. In another embodiment, the current supply unit 127 may be provided for every row, and the current supply unit 127 of each row may be shared by a plurality of pixels PXs in the same row.

In the above-described embodiment, the pixel includes P-type transistors, but the present disclosure embodiment is not limited thereto. In one or more embodiments, the pixel may include N-type transistors, and in this case, the pixel may be driven by a signal in which the level of the signal applied to the P-type transistors is inverted.

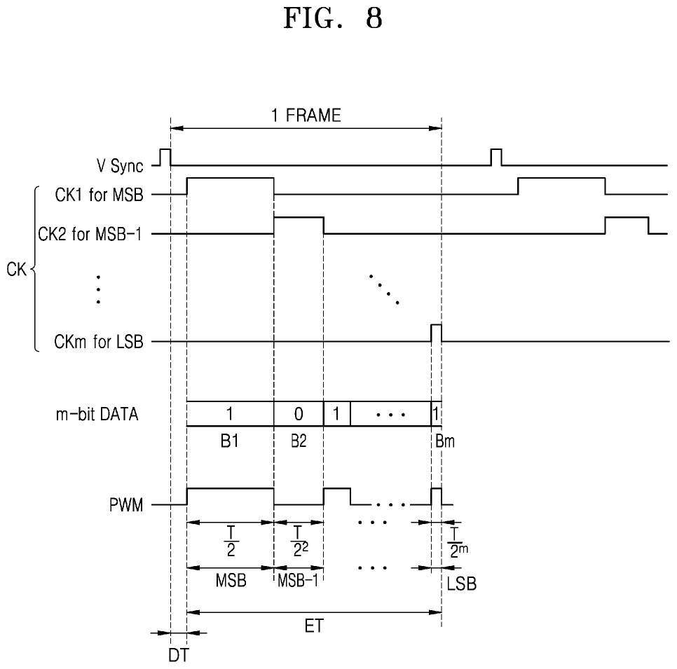

FIG. 8 is a diagram for describing driving of a pixel according to an embodiment of the present disclosure.

FIG. 8 illustrates an example of driving of a pixel of an arbitrary row, which is equally applicable to pixel driving of other rows. Referring to FIG. 8, the pixel PX may be driven in a data-writing period DT and a light-emitting period ET during a single frame. In the data-writing period DT, the bit value of the m-bit data from the data driving unit 125 may be recorded (stored) in the memory 403 in the pixel PX.

In the light-emitting period ET, the PWM controller 401 may generate a PWM signal based on m bit values of the m-bit data recorded in the memory 403 and m clock signals CK applied from the clock generator 129.

The m-bit data may be represented by m bits including a most significant bit MSB (B0) and a least significant bit LSB (Bm). The m-bit data recorded in the memory 403 may be sequentially read, from the most significant bit MSB (B0) to the least significant bit LSB (Bm).

The clock signals CK may include first through mth clock signals CK1 through CKm. The first through mth clock signals CK1 through CKm may be respectively applied for a same time as a time allocated to bits corresponding to the m-bit data. For example, when a first clock signal CK1 is applied for a time (T/2) allocated to the MSB (B1), and then a second clock signal CK2 is applied for a time (T/2²) allocated to the MSB-1 (B2), and then a third clock signal CK3 is applied for a time (T/2³) allocated to the MSB-2 (B3), and likewise an mth clock signal CKm may be applied for a time (T/2^{m}) allocated to the LSB (Bm).

In every frame, the PWM controller 401 may control a pulse width of a PWM signal based on a bit value of m-bit data read from the memory 403 and a signal width of a corresponding clock signal CK.

In FIG. 8, an embodiment in which the image data DATA has m bit values of 101 . . . 1 is illustrated. The PWM controller 401 may output a pulse having a pulse width of a first length (T/2) based on a bit value of 1 of MSB(B1) and the first clock signal CK1. The PWM controller 401 may turn off the pulse output for a second length (T/2²) based on a bit value of 0 of MSB-1(B2) and the second clock signal CK2. Likewise, the PWM controller 401 may output a pulse having a pulse width of an mth length (T/2^{m}) based on 1, which is a bit value of LSB(Bm), and the mth clock signal CKm.

The luminous element ED may emit light or may not emit light during a single frame according to the pulse output of the PWM signal. The luminous element ED may emit light for a time corresponding to the pulse width when the pulse output is turned on. The luminous element ED may not emit light as long as the pulse output is turned off.

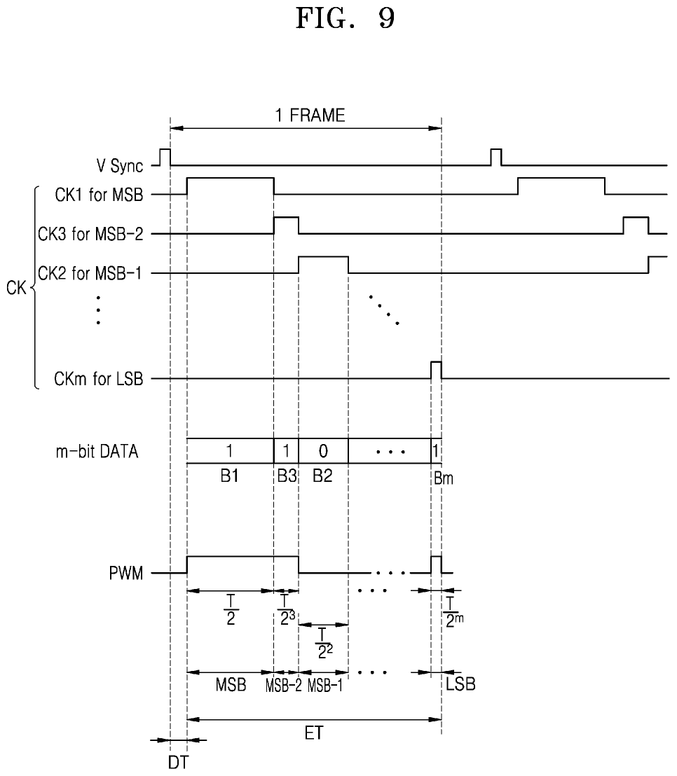

FIG. 9 is a diagram for explaining driving of a pixel according to another embodiment of the present disclosure.

FIG. 9 illustrates an example of driving of a pixel of an arbitrary row, which is equally applicable to pixel driving of other rows. In the embodiment of FIG. 9, the order in which m bits of m-bit data are read from the memory 403 is different from the one of the embodiment of FIG. 8.

Referring to FIG. 9, the pixel PX may be driven in a data-writing period DT and a light-emitting period ET during a single frame.

In the data-writing period DT, the bit value of the m-bit data from the data driving unit 125 may be recorded (stored) in the memory 403 in the pixel PX.

In the light-emitting period ET, the PWM controller 401 may generate a PWM signal based on m bit values of the m-bit data recorded in the memory 403 and m clock signals CK applied from the clock generator 129. Here, the reading order of the m bits is changed to be different from the order of the embodiment of FIG. 8, in which bits are sequentially read from the most significant bit MSB (B0) to the least significant bit LSB(Bm). FIG. 9 illustrates an embodiment in which a bit MSB-2(B3) at a third position, of the m bits, is read before a bit MSB-1(B2) at a second position. Clock signals CK may be output to correspond to positions of bits that are read. For example, when a first clock signal CK1 is applied for a time (T/2) allocated to the MSB(B1), and then a third clock signal CK3 is applied for a time (T/2³) allocated to the MSB-2(B3), and then a second clock signal CK2 is applied for a time (T/2²) allocated to the MSB-1(B2), and likewise, an mth clock signal CKm may be applied for a time (T/2^{m}) allocated to the LSB (Bm). The order in which the bits are read may be preset or changed.

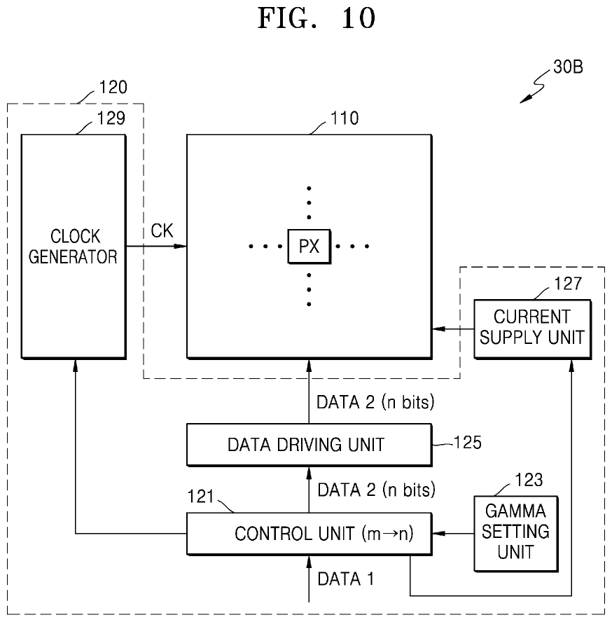

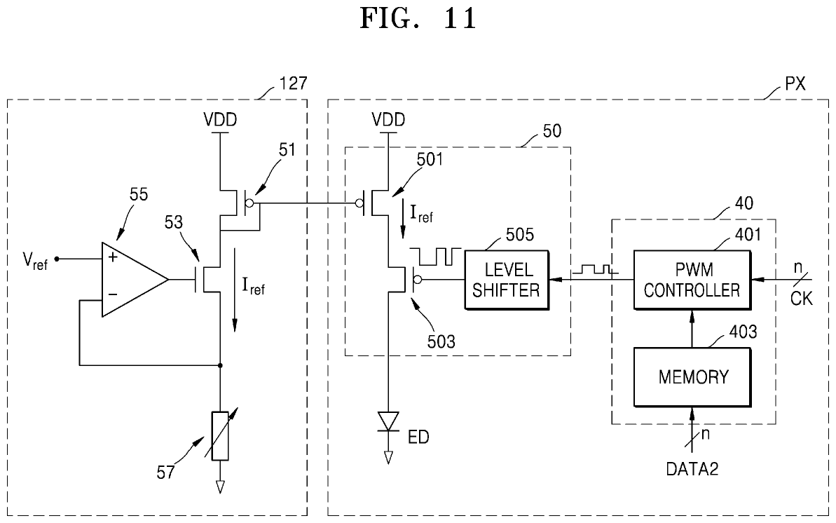

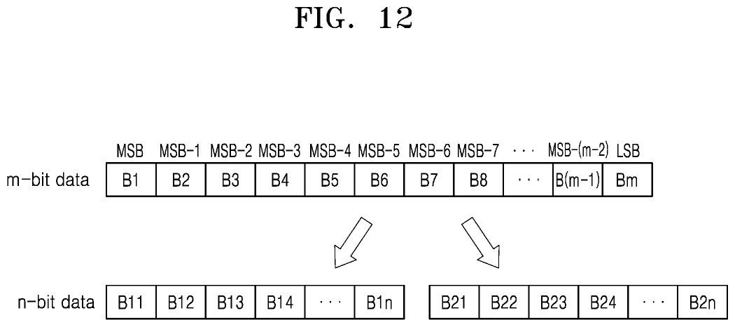

FIG. 10 is a diagram schematically illustrating a display device according to another embodiment of the present disclosure. FIG. 11 is a circuit diagram illustrating a pixel PX of the display device of FIG. 10. FIG. 12 is a diagram for describing data division by the display device of FIG. 10. Hereinafter, the above embodiment will be described by referring to FIGS. 10 through 12 together, and detailed description of the components provided above with reference to FIGS. 1 through 7 will be omitted.

A display device 30B may include a pixel unit 110 and a driving unit 120.

The pixel unit 110 may display an image by using an m-bit digital image signal capable of displaying 1 to 2^{m} gray scales. The pixel unit 110 may include a plurality of pixels PX arranged in a certain pattern, for example, a matrix-type pattern or a zigzag-type pattern. The pixel PX emits light of a single color, and may emit, for example, light of red, blue, green, or white. The pixel PX may emit light of other colors than red, blue, green, and white.

The pixel PX may include a luminous element. The luminous element may be a self-luminous element. For example, the luminous element may be an inorganic LED. A luminous element may be a micro-LED. The luminous element may emit light having a single peak wavelength or may emit light having a plurality of peak wavelengths.

The pixel PX may further include a pixel circuit connected to the luminous element. The pixel circuit may include at least one thin-film transistor and at least one capacitor. The transistor may be a CMOS transistor.

The pixel PX may operate in a frame unit. A single frame may include a plurality of subframes. Each subframe may include a data-writing period and a light-emitting period. During a data-writing period, digital data of certain bits may be applied to the pixel PX and stored therein. Digital data of certain bits stored during a light-emitting period may be synchronized with a clock signal to be read, and the digital data may be converted into a PWM signal, so that the pixel PX may express gradation. A period of a subframe, specifically, a light-emitting period of a subframe, may be a sum of times respectively allocated to bits of digital data.

The driving unit 120 may drive and control the pixel unit 110. The driving unit 120 may include a control unit 121, a gamma setting unit 123, a data driving unit 125, a current supply unit 127, and a clock generator 129.

The control unit 121 may receive input image data DATA1 of one frame from the outside (for example, a graphic controller), and receive a correction value from the gamma setting unit 123 to perform gamma correction on the input image data DATA1 by using the correction value, thereby generating correction image data DATA2.

The control unit 121 may extract gradation of each pixel PX from the correction image data DATA2 of one frame and convert the extracted gradation into digital data of a certain preset number of bits (for example, m bits).

The control unit 121 may divide the m-bit data into p pieces of n-bit data, where n is less than m. Here, p may be the number of subframes. p may be a number smaller than n. The control unit 121 may generate a plurality of bit strings of n-bit data by combining bits in the number of n, which is smaller than m, from among m bits that form a bit string of the m-bit data. The control unit 121 may generate p pieces of n-bit data by combining bits of the m-bit data such that a difference in periods of subframes is minimized. For example, when a frame includes two subframes, the control unit 121 may generate two bit strings of n-bit data from a bit string of m-bit data such that a difference in periods of the two subframes is minimized.

FIG. 12 illustrates an example in which m-bit data, which is a bit string including m bit values from MSB (B1) to LSB (Bm), into two pieces of n-bit data. n-bit data on the left is a bit string including n bit values from MSB (B11) to LSB (B1n). n-bit data on the right is a bit string including n bit values from MSB (B21) to LSB (B2n). In an embodiment, n may be (m/2)+1 or (m/2)−1. Two bit strings from among bit strings of n-bit data may include, as a common bit, at least one particular bit of the bit string of m-bit data. A time allocated to the common bit may be half a time allocated to that particular bit in the bit string of the m-bit data. For example, when p is 2, the control unit 121 may divide 10-bit data into two pieces of 6-bit data or three pieces of 4-bit data. Two pieces of 6-bit data may include, as a common bit, at least one of the most significant bit MSB and the next higher bit MSB-1 of the 10 bits. A time allocated to the common bit of the two 6-bit data may be half a time allocated to the most significant bit MSB and/or the next higher bit MSB-1 of the 10 bits. Two pieces of 4-bit data from among three pieces of 4-bit data may include, as a common bit, at least one of a most significant bit MSB and a second next higher bit MSB-2. A time allocated to the common bit of the two pieces of 6-bit data may be half a time allocated to the most significant bit MSB and/or a next higher bit MSB-1 of the 10 bits.

In another embodiment, n may be m/2. Bit strings of n-bit data may not include bits at same positions from among m bits, and sums of times allocated to bits of each of the bit strings of the n-bit data may be approximate to one another. For example, when p is 2, the control unit 121 may divide 10-bit data into two pieces of 5-bit data. Each bit of the two pieces of 5-bit data does not overlap each other.

The control unit 121 may distribute p pieces of n-bit data to p subframes and output the same to the data driving unit 125. A time (length) of a subframe may be equal to a sum of times respectively allocated to bits of n-bit data. A time allocated to each bit of the n-bit data may be a time allocated to a corresponding position in a bit string of m-bit data or half that time. Times of the subframes may be the same or different. The control unit 121 may generate a plurality pieces of n-bit data by combining bits of the m-bit data such that a time difference between the subframes (particularly, a difference in light-emitting period of the subframes) is minimized. The control unit 121 may generate a plurality pieces of n-bit data by dividing a time allocated to at least one of the most significant bit MSB, the next higher bit MSB-1, and the second next higher bit MSB-2, to which the longest time is allocated in the m-bit data.

Division and distribution of bit strings will be described in detail later.

The gamma setting unit 123 may set a gamma value using a gamma curve, set a correction value of image data according to a set gamma value, and output a set correction value to the control unit 121. The gamma setting unit 123 may be provided as a circuit separate from the control unit 121, or may be provided to be included in the control unit 121.

The data driving unit 125 may receive m-bit data from the control unit 121 in a subframe unit and transmit the same to each pixel PX of the pixel unit 110.

The data driving unit 125 may include a line buffer and a shift register circuit. The line buffer may be one line buffer or two line buffers. The data driving unit 125 may provide n-bit data to each pixel for every subframe in a line unit (a row unit).

The current supply unit 127 may generate and supply a driving current of each pixel PX. The structure of the current supply unit 127 is described with reference to FIGS. 5 through 7, and thus detailed description thereof will be omitted here.

The clock generator 129 may generate n clock signals for every subframe during a single frame and output the generated clock signals to pixels PX. n clock signals may be output to correspond to each bit of m-bit data. A signal width (length or ON time) of a clock signal may be determined according to a time allocated to each bit of m-bit data. The clock generator 129 may sequentially supply n clock signals to the clock line CL for every subframe.

The pixel PX may include a luminous element ED and a pixel circuit including a first pixel circuit 40 and a second pixel circuit 50 connected thereto. The structure of the pixel PX is described above with reference to FIG. 6, and thus detailed description thereof will be omitted.

The luminous element ED may selectively emit light or not emit light for every subframe during a single frame, based on a bit value (logic level) of image data provided from the data driving unit 125, thereby adjusting the light-emission time within the single frame to display gradation.

The first pixel circuit 40 may store bit values of n-bit data applied from the data driving unit 125 during a data-writing period for every subframe, and generate a first PWM signal based on n bit values and n clock signals during the light-emitting period. The first pixel circuit 40 may include the PWM controller 401 and the memory 403.

The PWM controller 401 may generate the first PWM signal based on a clock signal CK input from the clock generator 129 and a bit value of corresponding image data read from the memory 403 during the light-emitting period. A signal width of a clock signal may be equal to a time allocated to a bit position of a corresponding bit. The PWM controller 401 may control a pulse width of the first PWM signal based on a bit value of corresponding image data in a subframe unit and a signal width of a clock signal. In synchronization with a subframe start signal, the memory 403 may receive and store in advance the n-bit data applied through a data line DL from the data driving unit 125 during the data-writing period for every subframe.

Bit values (logic level) of n-bit data may be input from the data driving unit 125 to the memory 403 in a certain order. The memory 403 may store at least 1 bit data. In one embodiment, the memory 403 may be a memory of less than m bits. For example, the memory 403 may be an n-bit memory. n bit values of n-bit data may be recorded to the memory 403 during a data-writing period of a subframe. The memory 403 may be implemented as at least one transistor. The memory 403 may be implemented as a random access memory (RAM), for example, SRAM or DRAM.

When m-bit data is applied to the memory 403 without conversion, the memory 403 needs to have a capacity sufficient to store the m-bit data, and this may be a restriction factor in minimizing a pixel. When the memory 403 has 1-bit capacity, pixels are to be driven based on a plurality of subframes (for example, m subframes), and this increases driving frequency, and the increased driving frequency in turn increases current consumption, which in the case of battery-operated products may be a restriction factor. In addition, different times need to be allocated to each subframe. However, according to the embodiments of the present disclosure, memory capacity may be reduced by using an n-bit memory of less than m bits, as the memory 403, thereby reducing a pixel size. In addition, by using an n-bit memory, the number of subframes may be reduced compared to 1-bit memory, thereby maintaining an appropriate driving frequency.

The second pixel circuit 50 may control light-emission and non-emission of the luminous element ED in response to a control signal applied from the first pixel circuit 40 in each of a plurality of subframes during a single frame. The control signal may be a PWM signal. The second pixel circuit 50 may include a first transistor 501, a second transistor 503, and a level shifter 505 electrically connected to the current supply unit 127.

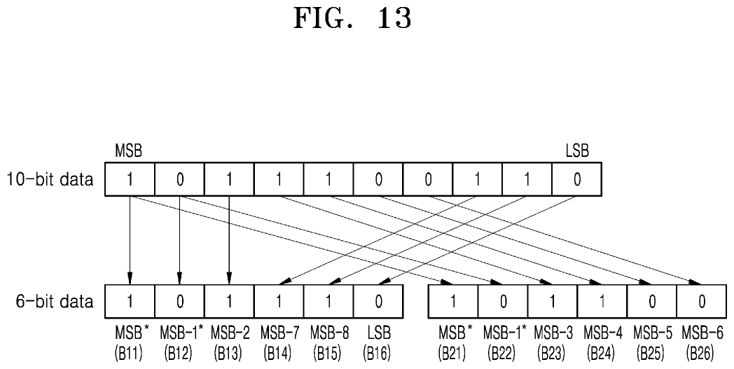

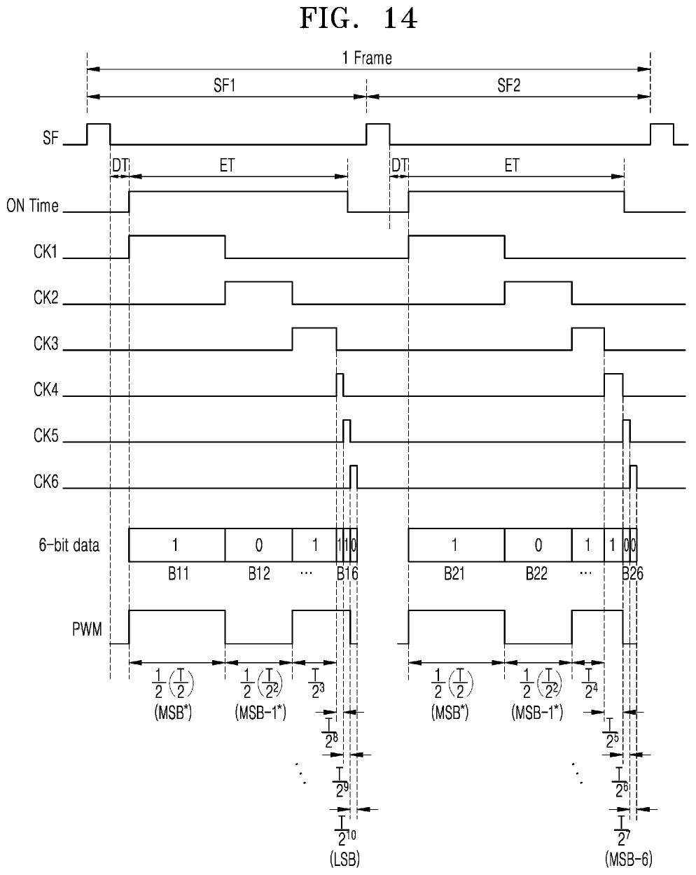

FIG. 13 is a diagram for describing bit data division according to an embodiment of the present disclosure. FIG. 14 is a diagram for describing driving timing of a clock signal according to an embodiment of the present disclosure. FIG. 14 illustrates an example of driving timing of a clock signal applied to an arbitrary row.

In FIGS. 13 and 14, an example is illustrated, in which one frame includes two subframes and a PWM signal is generated by two pieces of 6-bit data generated by dividing 10-bit data in each subframe.

Referring to FIG. 13, in a bit string (1011100110) of 10-bit data of a pixel PX, 1, which is the leftmost bit (B1), is the MSB, and 0, which is the rightmost bit (B10), is the LSB. 10-bit data may be divided into two bit strings of 6-bit data. Bits may be combined such that a difference between a time of a first subframe SF1 and a time of a second subframe SF2, specifically, a difference between a light-emitting period ET of the first subframe SF1 and a light-emitting period ET of the second subframe SF2 is minimized.

First 6-bit data (B11 through B16) is a combination (101110) of MSB(B1)*/MSB-1(B2)*/MSB-2(B3)/MSB-7(B8)/MSB-8(B9)/LSB(B10) of the 10-bit data (B1 through B10). Second 6-bit data (B21 through B26) is a combination (101100) of MSB(B1)*/MSB-1(B2)*/MSB-3(B4)/MSB-4(B5)/MSB-5(B6)/MSB-6(B7) of the 10-bit data (B1 through B10). Here, ‘*’ denotes that half (½) of a time allocated to a corresponding bit in the 10-bit data is allocated to the bit marked with ‘*’. That is, 1, which is the leftmost bit (B11, B21) of the first 6-bit data and the second 6-bit data, is 1 that is the most significant bit MSB (B1) of the 10-bit data, and is the common bit taken from the same position of the 10-bit data, and half of the time allocated to the MSB of the 10-bit data is allocated to each thereof. Likewise, 0, which is the second left bit (B12, B22) of the first 6-bit data and the second 6-bit data, is 0 that is the next higher bit MSB-1 (B2) of the 10-bit data, and is the common bit taken from the same position of the 10-bit data, and half of the time allocated to the MSB-1 is allocated to each thereof.

The first 6-bit data (left) is image data of the first subframe SF1, and the second 6-bit data (right) is image data of the second subframe SF2.

Referring to FIG. 14, the pixel PX may be driven in a data-writing period DT and a light-emitting period ET for every subframe of a single frame. An ON time of the light-emitting period ET makes up most of a time of a subframe, and thus, the term ‘a time of a subframe’ and the term ‘a light-emitting period’ may be interchangeable herein. A time of a first subframe and a time of a second subframe may be different but approximate. Hereinafter, ‘approximate’ may mean that the time of the first subframe and the time of the second subframe are equal or a difference therebetween is about 10% to about 20%.

In the data-writing period DT of the first subframe SF1, bit values of n-bit data from the data driving unit 125 may be recorded (stored) in the memory 403 in the pixel PX. That is, the bit string (101110) of the first 6-bit data (B11 through B16) of FIG. 13 may be recorded in the memory 403 in the pixel PX.

In the light-emitting period ET of the first subframe SF1, first through sixth clock signals CK1 through CK6 may be applied to the PWM controller 401 in synchronization with 6-bit data, and the PWM controller 401 may generate a PWM signal based on bit values of the 6-bit data recorded in the memory 403 and the first through sixth clock signals CK1 through CK6.

The first through sixth clock signals CK1 through CK6 of the first subframe SF1 may be each applied for a same time as a time allocated to each bit of the 6-bit data. For example, the first clock signal CK1 may be applied for ½×(T/2), half the time (T/2) allocated to the MSB. The second clock signal CK2 may be applied for ½×(T/2²), half the time (T/2²) allocated to the MSB-1. The third clock signal CK3 may be applied for (T/2³), the time allocated to the MSB-2. The fourth clock signal CK4 may be applied for (T/2⁸), the time allocated to the MSB-7. The fifth clock signal CK5 may be applied for (T/2⁹), the time allocated to the MSB-8. The sixth clock signal CK6 may be applied for (T/2¹⁰), the time allocated to the LSB.

In the data-writing period DT of the second subframe SF2, the bit value of the n-bit data from the data driving unit 125 may be recorded in the memory 403 in the pixel PX. That is, the bit string (101100) of the second 6-bit data (B21 through B26) of FIG. 13 may be recorded in the memory 403 in the pixel PX.

In the light-emitting period ET of the second subframe SF2, the first through sixth clock signals CK1 through CK6 may be applied to the PWM controller 401 in synchronization with the 6-bit data, and the PWM controller 401 may generate a PWM signal based on the bit value of the 6-bit data recorded in the memory 403 and the first through sixth clock signals CK1 through CK6.

The first through sixth clock signals CK1 through CK6 of the second subframe SF2 may be each applied for a same time as a time allocated to each bit of the 6-bit data. For example, the first clock signal CK1 may be applied for ½×(T/2), half the time (T/2) allocated to the MSB. The second clock signal CK2 may be applied for ½×(T/2²), half the time (T/2²) allocated to the MSB-1. The third clock signal CK3 may be applied for (T/2⁴), the time allocated to the MSB-3. The fourth clock signal CK4 may be applied for (T/2⁵), the time allocated to the MSB-4. The fifth clock signal CK5 may be applied for (T/2⁶), the time allocated to the MSB-5. The sixth clock signal CK6 may be applied for (T/2⁷), the time allocated to the MSB-6.

The PWM controller 401 may generate the PWM signal (PWM) based on the clock signal CK output from the first subframe SF1 and the second subframe SF2 and the bit value of the bit data. In each of the first subframe SF1 and the second subframe SF2, the PWM controller 401 may control a pulse width of a PWM signal based on the bit value of the 6-bit data read from the memory 403 and a signal width of a corresponding clock signal CK.

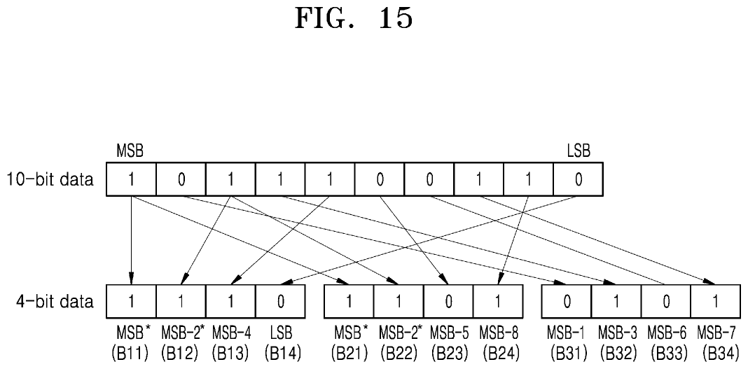

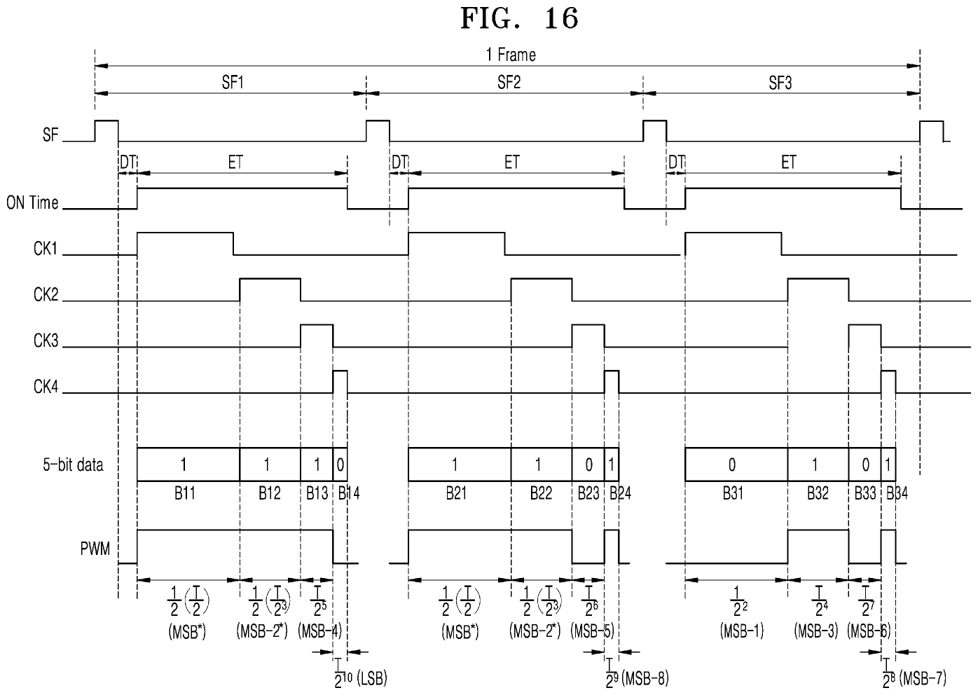

FIG. 15 is a diagram for describing bit data division according to another embodiment of the present disclosure. FIG. 16 is a diagram for describing driving timing of a clock signal according to another embodiment of the present disclosure. FIG. 16 illustrates an example of driving timing of a clock signal applied to an arbitrary row.

In FIGS. 15 and 16, an example is illustrated, in which one frame includes three subframes and, in each subframe, a PWM signal is generated by three pieces of 4-bit data generated by dividing 10-bit data.

Referring to FIG. 15, in a bit string (1011100110) of 10-bit data (B1 through B10) of a pixel PX, 1, which is the leftmost bit (B1) is the MSB, and 0, which is the rightmost bit (B10), is the LSB. 10-bit data may be divided into three bit strings of 4-bit data. Bit data may be combined such that a difference in times of first through third subframes SF1 through SF3, specifically, a difference in light-emitting periods ET of the first through third subframes SF1 through SF3 is minimized.

First 4-bit data (B11 through B14) is a combination (1110) of MSB(B1)*/MSB-2(B3)*/MSB-4(B5)/LSB(B10) of 10-bit data. Second 4-bit data (B21 through B24) is a combination (1101) of MSB(B1)*/MSB-2(B3)*/MSB-5(B6)/MSB-8(B9) of 10-bit data. Third 4-bit data (B31 through B34) is a combination (0101) of MSB-1(B2)/MSB-3(B4)/MSB-6(B7)/MSB-7(B8) of 10-bit data. Here, ‘*’ denotes that half (½) of a time allocated to a corresponding bit in the 10-bit data is allocated to the bit marked with ‘*’. That is, 1, which is the leftmost bit (B11, B21) of the first 4-bit data and the second 4-bit data, is 1 that is the most significant bit MSB (B1) of the 10-bit data, and is the common bit taken from the same position of the 10-bit data, and half of the time allocated to the MSB of the 10-bit data is allocated to each thereof. Likewise, 1, which is the second left bit (B12, B22) of the first 4-bit data and the second 4-bit data, is 1 that is the third bit MSB-2 (B3) of the 10-bit data, and is the common bit taken from the same position of the 10-bit data, and half of the time allocated to the MSB-2 is allocated to each thereof.

The first 4-bit data (left) is image data of the first subframe SF1, and the second 4-bit data (middle) is image data of the second subframe SF2, and the third 4-bit data (right) is image data of the third subframe SF3.

Referring to FIG. 16, the pixel PX may be driven in a data-writing period DT and a light-emitting period ET for every subframe of a single frame. A time of a first subframe and a time of a second subframe may be different but approximate.

In the data-writing period DT of the first subframe SF1, bit values of n-bit data from the data driving unit 125 may be recorded in the memory 403 in the pixel PX. That is, the bit string (1110) of the first 4-bit data (B11 through B14) of FIG. 15 may be recorded in the memory 403 in the pixel PX.

In the light-emitting period ET of the first subframe SF1, first through fourth clock signals CK1 through CK4 may be applied to the PWM controller 401 in synchronization with the 4-bit data, and the PWM controller 401 may generate a PWM signal based on bit values of the 4-bit data recorded in the memory 403 and the first through fourth clock signals CK1 through CK4.

The first through fourth clock signals CK1 through CK4 of the first subframe SF1 may be each applied for a same time as a time allocated to each bit of the 4-bit data. For example, the first clock signal CK1 may be applied for ½×(T/2), half the time (T/2) allocated to the MSB. The second clock signal CK2 may be applied for ½×(T/2³), half the time (T/2³) allocated to the MSB-2. The third clock signal CK3 may be applied for (T/2⁵), the time allocated to the MSB-4. The fourth clock signal CK4 may be applied for (T/2¹⁰), the time allocated to the LSB.

In the data-writing period DT of the second subframe SF2, the bit value of the n-bit data from the data driving unit 125 may be recorded in the memory 403 in the pixel PX. That is, the bit string (1101) of the second 4-bit data (B21 through B24) of FIG. 15 may be recorded in the memory 403 in the pixel PX.

In the light-emitting period ET of the second subframe SF2, the first through fourth clock signals CK1 through CK4 may be applied to the PWM controller 401 in synchronization with the 4-bit data, and the PWM controller 401 may generate a PWM signal based on the bit value of the 4-bit data recorded in the memory 403 and the first through fourth clock signals CK1 through CK4.

The first through fourth clock signals CK1 through CK4 of the second subframe SF2 may be each applied for a same time as a time allocated to each bit of the 4-bit data. For example, the first clock signal CK1 may be applied for ½×(T/2), half the time (T/2) allocated to the MSB. The second clock signal CK2 may be applied for ½(T/2³), half the time (T/2³) allocated to the MSB-2. The third clock signal CK3 may be applied for (T/2⁶), the time allocated to the MSB-5. The fourth clock signal CK4 may be applied for (T/2⁹), the time allocated to the MSB-8.

In the data-writing period DT of the third subframe SF3, the bit value of the n-bit data from the data driving unit 125 may be recorded in the memory 403 in the pixel PX. That is, the bit string (0101) of the third 4-bit data (B31 through B34) of FIG. 15 may be recorded to the memory 403 in the pixel PX.

In the light-emitting period ET of the third subframe SF3, the first through fourth clock signals CK1 through CK4 may be applied to the PWM controller 401 in synchronization with the 4-bit data, and the PWM controller 401 may generate a PWM signal based on the bit value of the 4-bit data recorded in the memory 403 and the first through fourth clock signals CK1 through CK4.

The first through fourth clock signals CK1 through CK4 of the third subframe SF3 may be each applied for a same time as a time allocated to each bit of the 4-bit data. For example, the first clock signal CK1 may be applied for (T/2²), the time allocated to the MSB-1. The second clock signal CK2 may be applied for (T/2⁴), the time allocated to the MSB-3. The third clock signal CK3 may be applied for (T/2⁷), the time allocated to the MSB-6. The fourth clock signal CK4 may be applied for (T/2⁸), the time allocated to the MSB-7.

The PWM controller 401 may generate the PWM signal (PWM) based on the clock signal CK output from the first through third subframes SF1 through SF3 and the bit value of the bit data. In each of the first through third subframes SF1 through SF3, the PWM controller 401 may control a pulse width of a PWM signal based on the bit value of the 4-bit data read from the memory 403 and a signal width of a corresponding clock signal CK.

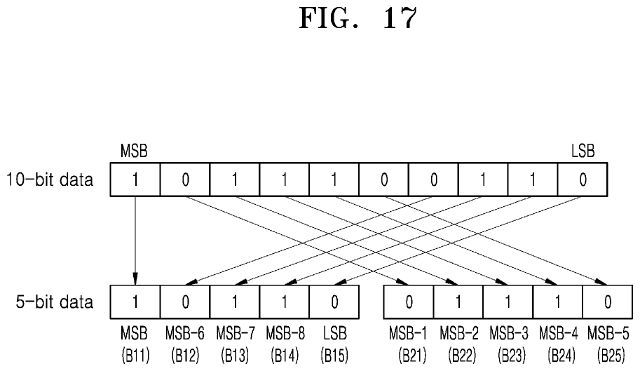

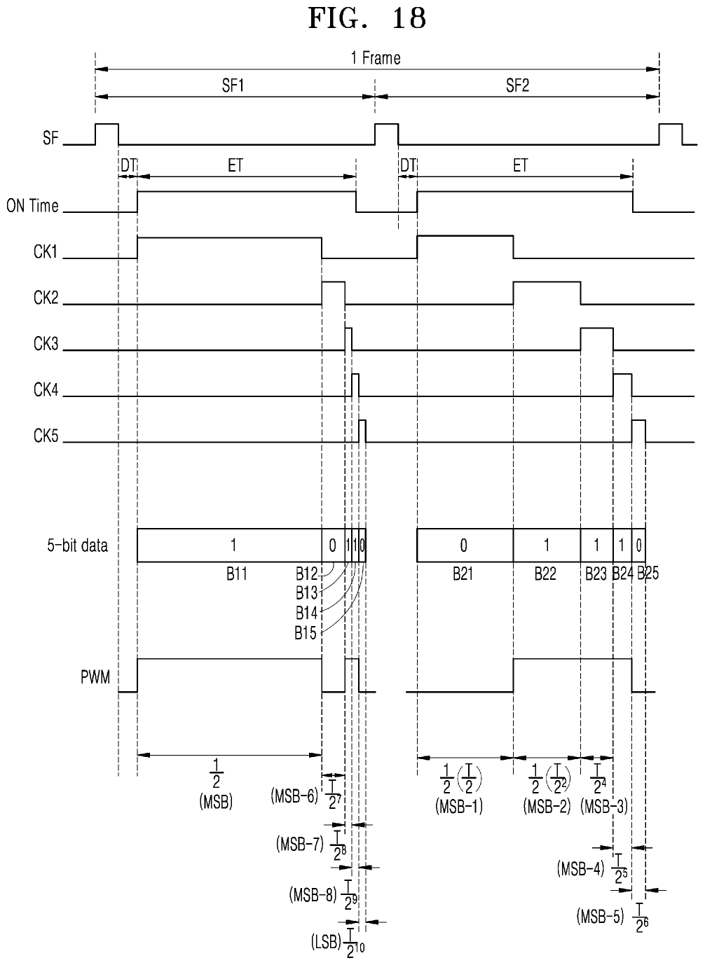

FIG. 17 is a diagram for describing bit data division according to another embodiment of the present disclosure. FIG. 18 is a diagram for describing driving timing of a clock signal according to another embodiment of the present disclosure. FIG. 18 illustrates an example of driving timing of a clock signal applied to an arbitrary row.

In FIGS. 17 and 18, an example is illustrated, in which one frame includes two subframes and a PWM signal is generated by two pieces of 5-bit data generated by dividing 10-bit data in each subframe.

Referring to FIG. 17, in a bit string (1011100110) of 10-bit data (B1 through B10) of a pixel PX, 1, which is the leftmost bit (B1), is the MSB, and 0, which is the rightmost bit (B10), is the LSB. 10-bit data may be divided into two bit strings of 5-bit data. Bits may be combined such that a difference between a time of a first subframe SF1 and a time of a second subframe SF2, specifically, a difference between a light-emitting period ET of the first subframe SF1 and a light-emitting period ET of the second subframe SF2 is minimized.

First 5-bit data (B11 through B15) is a combination (10110) of MSB(B1)/MSB-6(B7)/MSB-7(B8)/MSB-8(B9)/LSB(B10) of 10-bit data. Second 5-bit data (B21 through B25) is a combination (01110) of MSB-1(B2)/MSB-2(B3)/MSB-3(B4)/MSB-4(B5)/MSB-5(B6) of 10-bit data.

The first 5-bit data (left) is image data of the first subframe SF1, and the second 5-bit data (right) is image data of the second subframe SF2.

Referring to FIG. 18, the pixel PX may be driven in a data-writing period DT and a light-emitting period ET for every subframe of a single frame. An ON time of the light-emitting period ET is a time of a subframe, and a time of the first subframe and a time of the second subframe may be different but approximate to each other.

In the data-writing period DT of the first subframe SF1, bit values of n-bit data from the data driving unit 125 may be recorded in the memory 403 in the pixel PX. That is, the bit string (10110) of the first 5-bit data (B11 through B15) of FIG. 18 may be recorded in the memory 403 in the pixel PX.

In the light-emitting period ET of the first subframe SF1, first through fifth clock signals CK1 through CK5 may be applied to the PWM controller 401 in synchronization with 5-bit data, and the PWM controller 401 may generate a PWM signal based on the bit value of the 5-bit data recorded in the memory 403 and the first through fifth clock signals CK1 through CK5.

The first through fifth clock signals CK1 through CK5 of the first subframe SF1 may be each applied for a same time as a time allocated to each bit of the 5-bit data. For example, the first clock signal CK1 may be applied for (T/2), the time allocated to the MSB. The second clock signal CK2 may be applied for (T/2⁷), the time allocated to the MSB-6. The third clock signal CK3 may be applied for (T/2⁷), the time allocated to the MSB-6. The fourth clock signal CK4 may be applied for (T/2⁸), the time allocated to the MSB-7. The fifth clock signal CK5 may be applied for (T/2¹⁰), the time allocated to the LSB.

In the data-writing period DT of the second subframe SF2, the bit value of the n-bit data from the data driving unit 125 may be recorded in the memory 403 in the pixel PX. That is, the bit string (01110) of the second 5-bit data of FIG. 18 may be recorded in the memory 403 in the pixel PX.

In the light-emitting period ET of the second subframe SF2, first through fifth clock signals CK1 through CK5 may be applied to the PWM controller 401 in synchronization with the 5-bit data, and the PWM controller 401 may generate a PWM signal based on the bit value of the 5-bit data recorded in the memory 403 and the first through fifth clock signals CK1 through CK5.

The first through fifth clock signals CK1 through CK5 of the second subframe SF2 may be each applied for a same time as a time allocated to each bit of the 5-bit data. For example, the first clock signal CK1 may be applied for (T/2²), the time allocated to the MSB-1. The second clock signal CK2 may be applied for (T/2³), the time allocated to the MSB-2. The third clock signal CK3 may be applied for (T/2⁴), the time allocated to the MSB-3. The fourth clock signal CK4 may be applied for (T/2⁵), the time allocated to the MSB-4. The fifth clock signal CK5 may be applied for (T/2⁶), the time allocated to the MSB-5.

The PWM controller 401 may generate the PWM signal (PWM) based on the clock signal CK output from the first subframe SF1 and the second subframe SF2 and the bit value of the bit data. In each of the first subframe SF1 and the second subframe SF2, the PWM controller 401 may control a pulse width of a PWM signal based on the bit value of the 5-bit data read from the memory 403 and a signal width of the clock signal CK.

In the embodiments of FIGS. 13 through 18, when a bit value is 1, the PWM controller 401 may output a pulse having a pulse width corresponding to a signal width of a clock signal CK. When a bit value is 0, the PWM controller 401 may not output a pulse corresponding to a signal width of a clock signal CK. In another embodiment, when a bit value is 1, the PWM controller 401 may not output a pulse corresponding to a signal width of a clock signal CK, and when a bit value is 0, the PWM controller 401 may output a pulse having a pulse width corresponding to a signal width of a clock signal CK.

The luminous element ED may emit light or may not emit light during a single frame according to the pulse output of the PWM signal. The luminous element ED may emit light for a time corresponding to the pulse width when the pulse output is turned on. The luminous element ED may not emit light as long as the pulse output is turned off.

An embodiment of the present disclosure may be implemented as a micro-LED display device. Recently, as the need for a micro-display device as a new display device increases, the development of micro LED on silicon or AMOLED on silicon that forms LEDs on silicon is on the rise, and the demand for reduction in power consumption in portable display devices is expected to increase.

The pixel according to the embodiments of the present disclosure may include a pixel circuit that switches a current source for current driving, and a switching signal may be generated by a combination of digital data and a timing signal that expresses gray level (gradation).

According to the pixel of the embodiments of the present disclosure, digital data may be divided into multiple subframes within a single frame and stored therein, thereby reducing the required memory bit number per pixel.

In the embodiments of the present disclosure, a memory is provided in a pixel to enable current driving, and in the case of a still image, the driving unit only needs to transmit a simple driving pulse to the pixel unit, and thus, power consumption may be improved.

According to the embodiments of the present disclosure, by PWM driving, a high bias current may be used in low gradation to thereby ensure excellent matching characteristics between pixels and realize a high color depth with a small size.

In the embodiments of the present disclosure, a target gamma value may be set through digital processing, and luminance may be easily adjusted using the current mirror circuit while the set gamma value is maintained.

In the embodiments of the present disclosure, a high-resolution display device can be implemented with a circuit configuration mainly based on a low voltage transistor.

In the present specification, the present disclosure has been described through limited embodiments, but various embodiments are possible within the scope of the present disclosure. Also, although not explained, it will be said that an equal means is also directly coupled to the present disclosure. Therefore, the true scope of protection of the present disclosure should be determined by the following claims.

1. A pixel comprises a luminous element and a pixel circuit connected to the luminous element, wherein
the pixel circuit includes:
a first pixel circuit comprising a memory storing bit values of multi-bit data corresponding to image data of a single frame and a pulse width modulation (PWM) controller configured to generate a PWM signal based on the bit values and a clock signal that is output in accordance with each bit of the multi-bit data; and
a second pixel circuit configured to adjust a light-emission time and a non-light-emission time of the luminous element during a single frame in response to the PWM signal.

2. The pixel of claim 1, wherein
the second pixel circuit includes:
a first transistor outputting a driving current and
a second transistor transmitting or blocking the driving current to the luminous element according to the PWM signal.

3. The pixel of claim 2, wherein
the second pixel circuit further includes
a level shifter that converts a voltage level of the PWM signal between the second transistor and the second pixel circuit.

4. The pixel of claim 2, wherein the first transistor forms a current mirror circuit with an external circuit of the pixel.

5. The pixel of claim 1, wherein
the memory receives bit values of the multi-bit data from a driving unit outside the pixel during a data-writing period of the frame,
the PWM controller generates the PWM signal during a light-emitting period subsequent to the data-writing period, and
the second pixel circuit adjusts a light emission time and a non-emission time of the luminous element during the light-emitting period.

6. The pixel of claim 1, wherein
the frame includes a plurality of subframes,
each of the plurality of subframes includes a data-writing period and a light-emitting period,
during a data-writing period of each subframe, the memory receives, from the driving unit outside the pixel, and stores a corresponding bit string from among a plurality of bit strings of n-bit data, wherein the plurality of bit strings are generated by a combination of bits in the number of n, which is smaller than m, from among m bits constituting a bit string of the multi-bit data,
during a light-emitting period of each subframe, the PWM controller generates the PWM signal based on n bit values of the corresponding bit string stored in the memory and n clock signals,
the number of the bit strings of the n-bit data is equal to the number of the subframes,
a light-emitting period of each subframe is a sum of times respectively allocated to bits of the corresponding bit string, and
the n-bit data is a bit string in which n bits from among the m bits are combined such that a difference in light-emitting periods of the plurality of subframes is minimized.

7. The pixel of claim 6, wherein
n is (m/2)+1 or (m/2)−1, and
two bit strings from among the bit strings of the n-bit data include, as a common bit, at least one bit of the bit string of the m-bit data, and a time allocated to the common bit is half a time allocated to the at least one bit in the bit string of the m-bit data.

8. The pixel of claim 6, wherein
n is m/2,
the bit strings of the n-bit data do not include bits at the same positions among the m bits, and
sums of time allocated to each bit of the respective bit strings of the n-bit data are approximate to one another.

9. A display device comprises:
a pixel unit in which a plurality of pixels are arranged, each pixel including a luminous element and a pixel circuit connected to the luminous element; and
a driving unit arranged around the pixel unit,
wherein
the driving unit comprises:
a data driving unit providing bit values of multi-bit data corresponding to image data of a single frame, to the plurality of pixels; and
a clock generator supplying a clock signal to the plurality of pixels, and
wherein
each pixel circuit of the plurality of pixels comprises:
a first pixel circuit comprising a memory storing bit values of multi-bit data applied from the data driving unit and a pulse width modulation (PWM) controller configured to generate a PWM signal based on the bit values and on a clock signal that is output in accordance with each bit of the multi-bit data applied from the clock generator; and
a second pixel circuit configured to adjust a light-emission time and a non-light-emission time of the luminous element during a single frame in response to the PWM signal.

10. The display device of claim 9, wherein
the memory receives bit values of the multi-bit data from a data driving unit during a data-writing period of the frame,
the PWM controller generates the PWM signal during a light-emitting period subsequent to the data-writing period, and
the second pixel circuit adjusts light emission and non-emission times of the luminous element during the light-emitting period.

11. The display device of claim 9, wherein
the frame includes a plurality of subframes,
each of the plurality of subframes includes a data-writing period and a light-emitting period,
during a data-writing period of each subframe, the memory receives, from the data driving unit, and stores a corresponding bit string from among a plurality of bit strings of n-bit data, wherein the plurality of bit strings are generated by a combination of bits in the number of n, which is smaller than m, from among m bits constituting a bit string of the multi-bit data,
the PWM controller generates the PWM signal based on n bit values of a corresponding bit string, stored in the memory, and n clock signals, during a light-emitting period of each subframe, and the number of the bit strings of the n-bit data is equal to the number of the subframes,
a light-emitting period of each subframe is a sum of times respectively allocated to bits of the corresponding bit string, and
the n-bit data is a bit string in which n bits from among the m bits are combined such that a difference in light-emitting periods of the plurality of subframes is minimized.

12. The display device of claim 11, wherein
n is (m/2)+1 or (m/2)−1, and
two bit strings from among the bit strings of the n-bit data include, as a common bit, at least one particular bit of the bit string of the m-bit data, and a time allocated to the common bit is half a time allocated to the at least one particular bit in the bit string of the m-bit data.

13. The display device of claim 11, wherein
n is m/2,
the bit strings of the n-bit data do not include bits at the same positions among the m bits, and
sums of time allocated to each bit of the respective bit strings of the n-bit data are approximate to one another.
